(19) United States
(12) Patent Application Publication
(10) Pub. No.: US 2005/0120606 A1
(43) Pub. Date: Jun. 9, 2005

(54) Door mat communication device and method

(76) Inventor: Fred Stanley, Houston, TX (US)

Correspondence Address: LAW OFFICE OF DAVID MCEWING, P.O. BOX 231324, HOUSTON, TX, 77023, US

(21) Appl. No.: 10/731,209

(22) Filed: Dec. 9, 2003

(51) Int. Cl. G09F 7/00

(52) U.S. Cl. 40/584

(57) ABSTRACT

A method and means for improved information and decorative communication function of floor or other surface covering materials, such as door or floor covering mats, by the coordination of information or design appearing on the covering materials that can be placed on both sides of a door or passageway.

### BACKGROUND OF INVENTION

1. Field of Use

The present invention has many applications for providing communication to persons approaching and traversing through an entranceway, particularly an entranceway separating an outer and inner area. The entranceway can be a doorway of a residence or commercial facility, including a doorway within the interior of a larger enclosed facility.

2. Prior Art

All homes or residences utilize the door separating the public exterior area from the private interior. Many individuals use various articles to decorate, identify or distinguish their residence. Examples of such devices include floral decorations placed on the door and doormats placed in front of the door.

Commercial establishments also use their entryways as locations to provide identification and advertising. Typically, the door surface or wall surface proximate to the door is used to identify the commercial entity.

These efforts and devices are typically separate and uncoordinated from the interior decorative theme or signage. There is no color, graphic, decorative, informational or directional continuity between the exterior area and the interior area.

Doormats are often placed on the floor surface proximate to the exterior or outside the entrance or entry door. Doormats have been used to provide protection of floor coverings from dirt and debris otherwise tracked into an interior space. Doormats also are used to provide protection from slipping on wet floor surfaces. Doormats are also placed in the interior area proximate to the entrance.

Doormats have also been used to convey messages or selected themes. Doormats have been used to provide welcome messages or identify the occupants of the residence or business space accessed by the door or passageway. Doormats can be used as part of the outside decor or decoration of the business or residence, displaying themes or colors.

Various methods and devices have also been utilized to communicate information to persons approaching a doorway or passageway. Signs are typically placed on the exterior door surface or proximate to the door or passageway. Important emergency exit information is also conveyed on the door surface or typically above the doorway. Additional location or direction information is often communicated after passing through the doorway by similar wall mounted signs.

Changes in the configuration of business organizations and space utilization require change in the signs. This can be a difficult or time consuming task.

It is an object of the present invention to provide a method and means to enhance the design or decorative function of doormats by providing a coordinated motif or theme. It is a further object of the invention to provide a method and means for enhanced location and directional information. Other objectives and advantages of the invention will be apparent to persons skilled in the technology after review of the information contained in this disclosure. Such objectives and advantages are claimed within the scope of this invention.

### SUMMARY OF INVENTION

The method and apparatus taught by the invention subject of this specification utilizes the ability to provide a door mat system or arrangement utilizing multiple mat components or a combination of separate mats or similar coverings having a common or interrelated message or theme proximate to the both sides (i.e., exterior and interior) of a door or entry way. The invention utilizes a continuity of a selected message or theme. The message can be a combined identity and welcoming message. The theme can be a design or color that transcends across the portal or entryway, facilitating the identity or purpose of the location to a visitor.

### SUMMARY OF DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 illustrates the placement of floor mats subject of the invention in relation to an entry or doorway.

FIG. 2 is a schematic illustration of one embodiment of the invention.

FIG. 3 is a schematic illustration of another embodiment of the invention.

FIGS. 4 through 9 are schematic illustrations of other embodiments of the invention.

The above general description and the following detailed description are merely illustrative of the subject invention, and additional modes, advantages and particulars of this invention will be readily suggested to those skilled in the art without departing from the spirit and scope of the invention.

### DETAILED DESCRIPTION OF INVENTION

Often great care and considerable expense in used in creating a desired decorative theme or motif in the entrance areas of residences and commercial entities. Wall and floor coverings, material and colors, as well as furniture and accessories are selected to compliment or maintain continuity with such theme or motif. In addition, commercial entities seek to create separate and readily recognizable identities. These efforts may utilize trademarked symbols, color patterns, names or combinations of the each element.

In many commercial office spaces or business locations, exterior signage is restricted or of limited availability. This is of particular concern at the entrance doorway of an individual business located within a multi business complex.

In large public facilities, such as hospitals, government buildings and airports, providing directional information to is a continual problem. Signs located on doors, walls or overhead are commonly used. However, directional or location information can also be communicated by floor markings.

All of these goals and objectives can be combined with devices for controlling dirt and debris and for protecting floor surfaces. The present invention is not limited to locations separated by a door. The invention can be located proximate to both of the entrance or passageway. It may also be located within the entrance or passageway.

The present invention utilizes floor covering materials, such as floor mats or removable floor coverings such as small rugs or carpets, or similar devices suitable for interior or outside use (“mats”) to provide an enhanced continuity with one or more the decorative themes that may exist on one or both sides of an entrance or passage way. The mats can provide personalized information. The mats can incorporate multiple materials and colors. The mats subject of the invention may also contain directional or identification information that may be particularly advantageous for commercial use.

The invention utilizes a mat having two components, i.e., a component that is visible primarily on one side of the door or passageway, and a second component visible after passing through the door or passageway. The components may be attached or be separate.

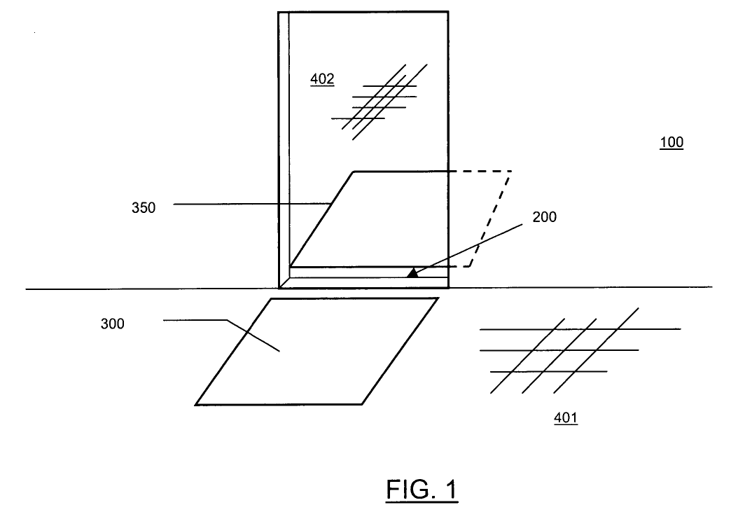

FIG. 1 illustrates the placement of two mats 300 350 located on opposite sides of a doorway or entranceway 200 communicating between to areas separated by a wall 100. One mat 300 is placed on the floor 401 of the first side (or “exterior side”) of the entranceway 200 and the second mat 350 is placed on the floor 402 of the second side (or “interior side”). These designations will be used in describing the invention within this specification and drawings.

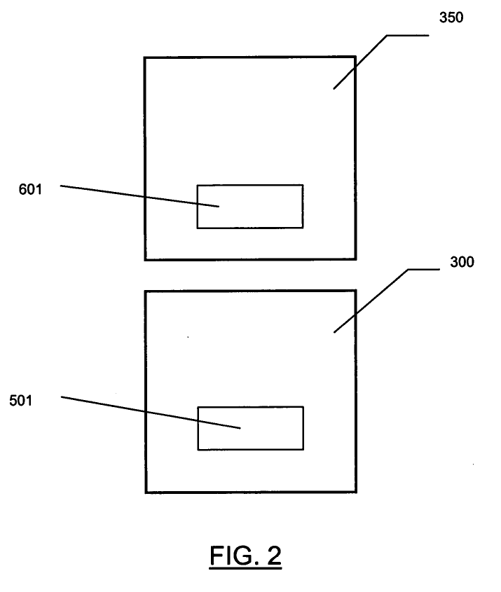

FIG. 2 illustrates an overhead view of two mats 300 350 subject of the invention placed in a relationship contemplated by one embodiment of the invention within an entranceway (not shown) or separated by the entranceway. Also depicted are areas 501 601 within each mat where text or other messaging can be placed. In keeping with the designations established for FIG. 1, the bottom mat 300 depicted in FIG. 2 is the exterior mat and may contain a message such as “welcome.” The upper mat 350 may contain the message “how are you?”. In another variation the text may be “welcome” and “come again”. In yet another variation, the text contained in the interior mat 350 may state “exit” and the text of the exterior mat 300 may state “entrance” or “no exit”. It will be appreciated by persons skilled in the art that the placement of exit messages or identification on a floor covering will provide advantage for identification of such exits in emergencies, particularly in smoke filled conditions requiring the occupants to crawl along the floor surface.

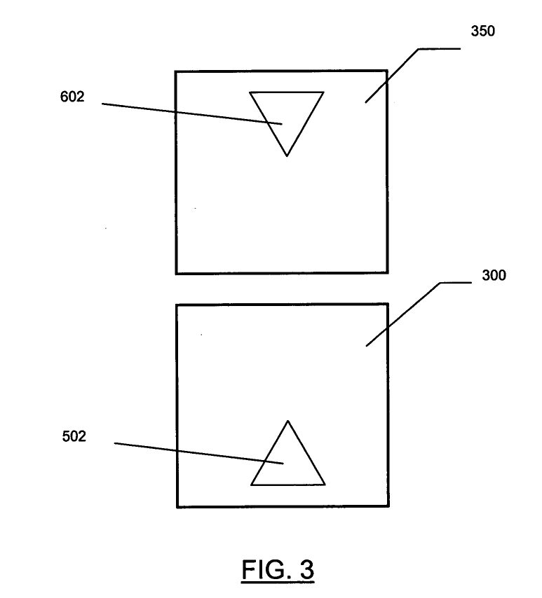

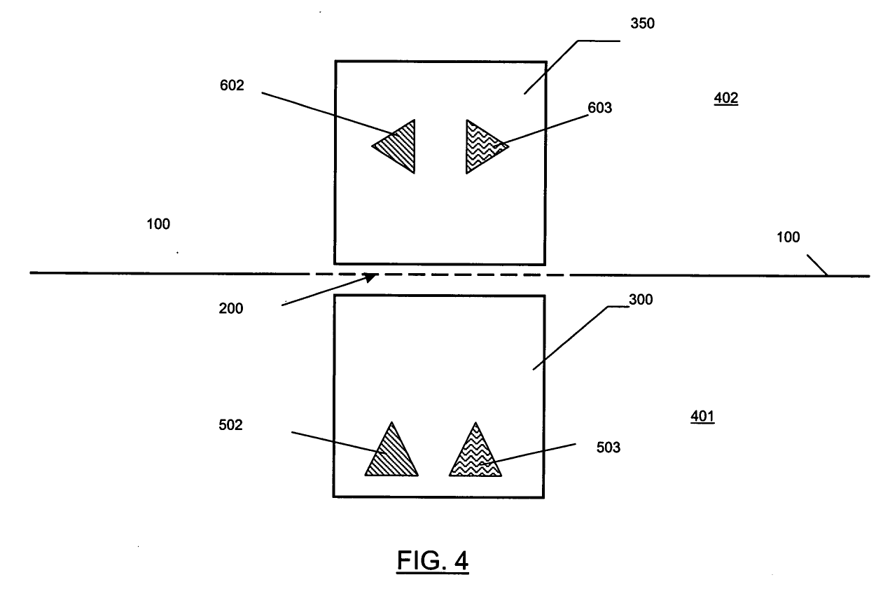

FIG. 3 illustrates an overhead view of two mats 300 350 each containing direction information 502 602. FIG. 4 depicts another overhead view similar to that depicted in FIG. 3 and wherein the directional arrows 502 503 on the exterior mat 300 are color coded with corresponding directional arrows 602 603 contained on the interior mat 350. It is envisioned that this may be beneficial for use as part of a hospital or clinic directional system. FIG. 4 also illustrates the location of a separating wall or barrier 100 and entranceway 200. The interior floor 402 and exterior floor 401 are also depicted.

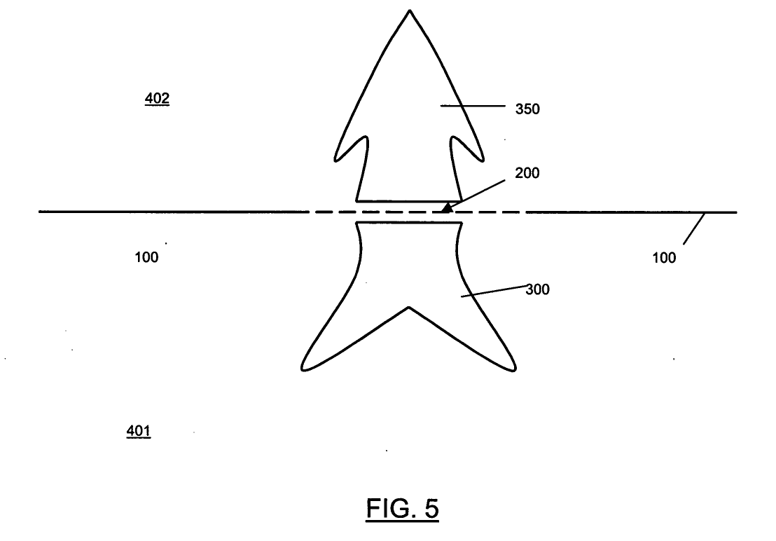

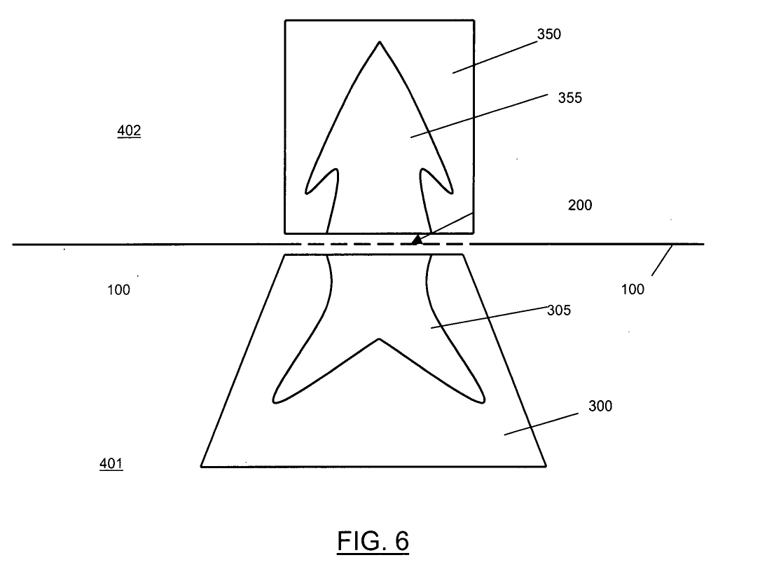

FIG. 5 illustrates a system of separately shaped but coordinated and visually communicating mats 300 350 in relation to a wall 100 and entranceway 200. The mats together effectively communicate to the observer that the travel through the entranceway is intended. The interior floor 402 and exterior floor area 401 are also depicted. FIG. 6 depicts a similar mat system but wherein the mats 300 350 are of a more regular or conventional shape, but the message is conveyed by the designs 305 355 on the mats.

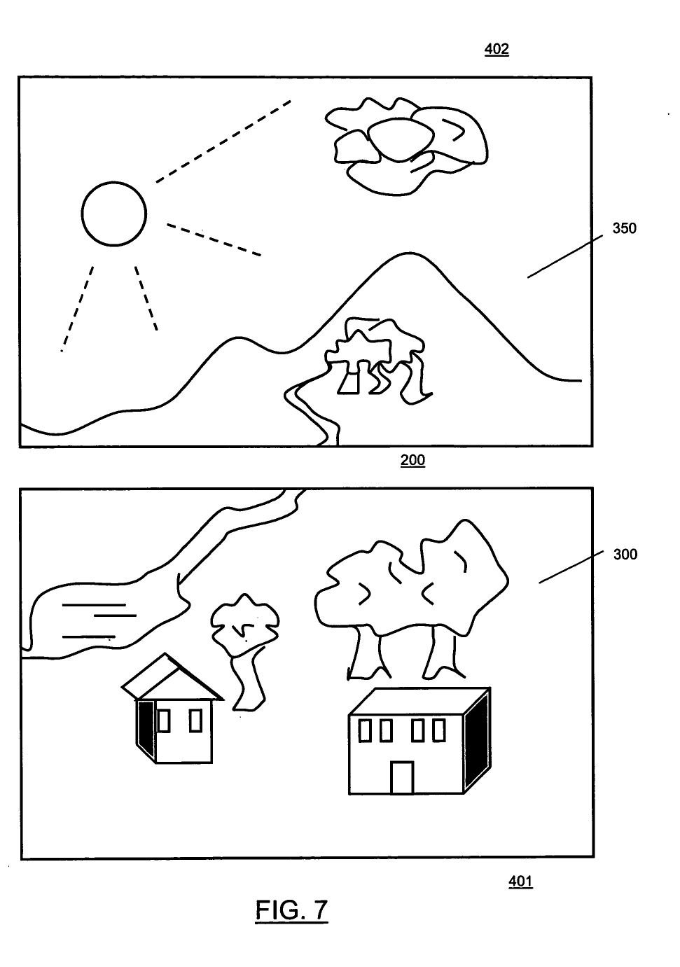

FIG. 7 illustrates an overhead view of a decorative coordinated mat system comprised of two mats 300 350 again having separate designs but that are coordinated into a composite composition having an intended motif or theme. The theme can be coordinated with either the interior area 402 or exterior area 401 or both. The relationship of each mat to the entranceway 200 connecting the interior and exterior floor areas is also illustrated.

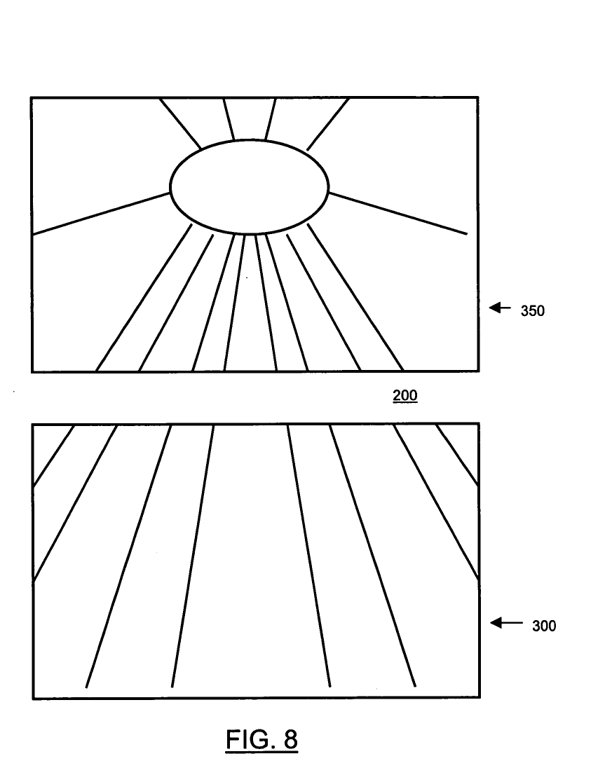

FIG. 8 illustrates another variation of the coordinated mat system comprised of two mats 300 350 proximate to an entranceway 200. It will be appreciated that the colors or materials within the mat can be coordinated as part of the design and function.

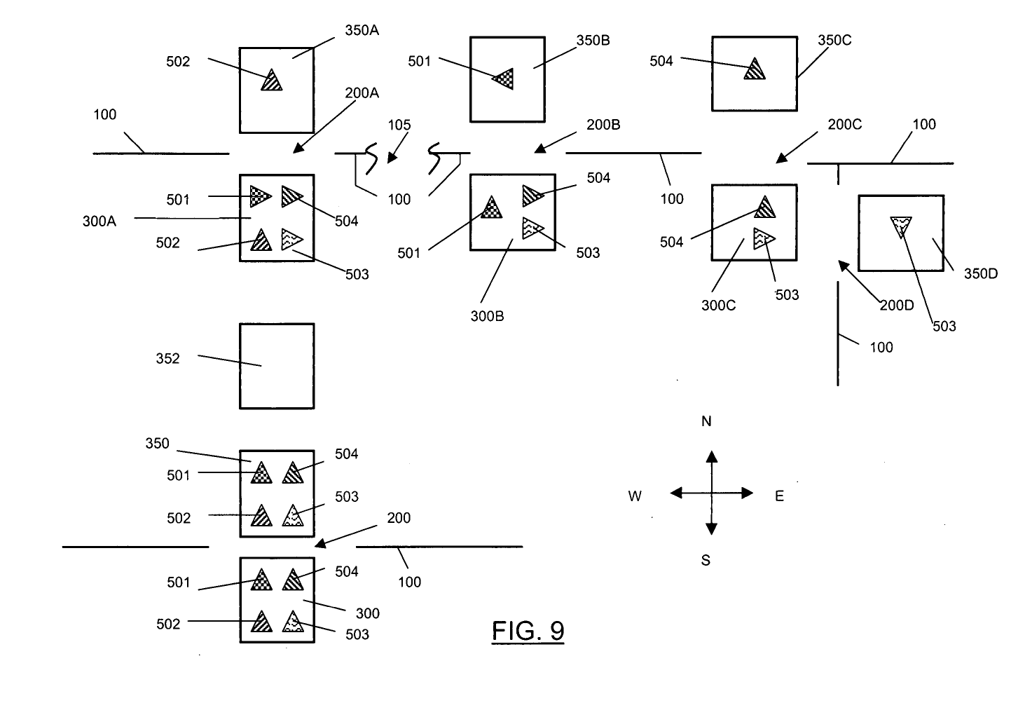

FIG. 9 is an illustration of the invention utilized to provide directional information applicable to a multiple of passages 200, 200A, 200B, 200C, 200D within spaces 100, including but not limited-to walls or moveable partitions. For purpose of describing the invention as illustrated in FIG. 9, directional orientation is illustrated as north N south S east E and west W. The invention comprises a plurality of components, being separate mats 300, 350, 300A, 350A, 300B, 350B, 300C, 350C and 350D placed proximate to passages. Each mat displays directional information. In the illustrated embodiment, the information is conveyed by multiple colored or patterned arrows 501, 502, 503, 504. The arrows or the colors/patterns may be correlated to different departments, rooms, terminal buildings, or similar physical destinations. The directional information may be supplemented by or substituted with text or other symbols. Referring specifically to the FIG. 9, the first mat 300 directs the user to proceed north through passage 200 for all destinations identified by the 4 arrows 501, 502, 503, 504. At the opposite side of the passage, the second mat 350 directs the user to continue north. If the distance to be traversed in long, it may be useful to have additional mats 352 placed on the floor duplicating the information (not shown) of the second mat 350. A third mat 300A directs the user to proceed east for the destinations identified by 3 arrows 501, 503, 504. If the destination identified by the forth arrow or symbol, 502, the user is directed to proceed north through passage 200A. The user passing through the passage encounters another mat 350A continuing the directional symbol 502 directing him/her to continue north.

Users seeking destinations identified by the 3 symbols 501, 503, 504 are directed to proceed east an unspecified distance 105 until another mat 300B is encountered. This mat directs the user seeking the destination identified by on symbol 501 to turn north and proceed through the passage 200B. After passing through this passage, the user is directed by a mat 350B to proceed west. This directional information is conveyed by the direction of the symbol or arrow 501 contained within the mat 350B. However, the mat 300B located proximate to the passage 200B directs users seeking the destinations identified by the other two symbols 503 504 to continue east. A further mat 300C directs users seeking one destination 504 to proceed north through passage 200C and users seeking the other destination 503 to continue east through passage 200D. Additional directional information is contained in the component, i.e., mat, 350C 350D of the invention placed proximate to the other side of the respective passageway 200C 200D.

It will be appreciated that the mats can be removed for cleaning, facilitate the maintenance of clean and dry floor surfaces in other parts of the building as well as provide means to readily change directional or location identification.

This specification is to be construed as illustrative only and is for the purpose of teaching those skilled in the art the manner of carrying out the invention. It is to be understood that the forms of the invention herein shown and describe are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention may be utilized independently of the use of other features, all as would be apparent to one skilled in the art after having the benefit of this description of the invention.

Further modifications and alternative embodiments of this invention will be apparent to those skilled in the art in view of this specification.

1. A method for improving commercial and residential entrances and interior door passages comprising:
a. creating at least two floor mats having visually observable coordinated content;
b. placing a first mat on a floor space proximate to a first side of passage area; and
c. placing a second mat on a floor space proximate to a second side of said passage area.

2. The method of claim 1 wherein the visually observable coordinated content comprises color.

3. The method of claim 1 wherein the coordinated content comprises design.

4. The method of claim 1 wherein the coordinated content is text information.

5. A method for improving commercial and residential entrances and interior door passages comprising the use of a plurality of floor surface mats having coordinated color, design or information content.

6. The method of claim 5 wherein the color or design content is coordinated with the at least one element selected from a group comprising the floor surface on a first side of the door passage, a second side of the door passage, a wall color on the first side of the door passage, a wall color on the second side of the door passage, a decorative theme on the first side of the door and the decorative theme on the second side of the door passage.

7. A floor surface mat system comprising at least two floor surface mats placed in a proximate relationship to the other and a passage way wherein each mat contains visually observable color, shape, design or informational content that is coordinated with the other mat.
